(19) United States
(12) Patent Application Publication
(10) Pub. No.: US 2002/0142933 A1
(43) Pub. Date: Oct. 3, 2002

(54) Charge-modified dye absorption media

(76) Inventors: Eslran B. Yeh, Unionville, CT (US); Eugene A. Ostreicher, Farmington, CT (US); Thomas D. Holler, Glastonbury, CT (US); Thomas J. Hamlin, Vernon, CT (US); William H. Caco, Southington, CT (US); Marjorie B. Bucholz, Meriden, CT (US); Jack L. Armack, Plantsville, CT (US)

Correspondence Address: CUMMINGS & LOCKWOOD, Four Stamford Plaza, P.O. Box 120, Stamford, CT, 06904-0120, US

(21) Appl. No.: 09/922,880

(22) Filed: Aug. 6, 2001

Related U.S. Application Data
(60) Provisional application No. 60/223,184, filed on Aug. 4, 2000.
(60) Provisional application No. 60/223,183, filed on Aug. 4, 2000.

(51) Int. Cl. C11D 17/00

(52) U.S. Cl. 510/297; 510/515

(57) ABSTRACT

A modified matrix, presently preferred to be a polyester substrate, having been reacted with a modifier, the modifier presently preferred to have one or more epoxy groups which bond to the matrix to change the characteristics of the matrix, thus permitting the matrix to be suitable for use in a variety of applications, such as a dye scavenger capable of absorbing dyes bled into solution.

### CROSS-REFERENCE TO RELATED APPLICATIONS

This application is a continuation-in-part of commonly owned U.S. Provisional Patent Application Serial No. 60/223,184 of Yeh, et al., filed Aug. 4, 2000, entitled “CHARGE-MODIFYIED DYE ABSORPTION MEDIA” and related to partially commonly owned U.S. Provisional Patent Application Serial No. 60/223,183 of Bucholz, et al, filed Aug. 4, 2000, entitled “METHOD FOR CHARGE-MODIFYING POLYESTER,” the disclosures of which are incorporated herein by reference to the extent not inconsistent with the present application.

### BACKGROUND OF THE DISCLOSURE

The present invention relates to charge-modifying polyester for use in a wide variety of applications, such as a laundry product for inhibiting the deposition of dye onto fabric. More particularly, the present invention is directed to compositions and methods useful for inhibiting the transfer of dyes. The products and processes of the present invention find particular use in inhibiting the transfer of the dye from one fabric to another fabric or from one area of a fabric to a different area of the same fabric.

Fabric dyes frequently bleed into solution when the fabrics to which they have been applied are laundered. Dye bleeding is particularly problematic the first time a fabric is washed. Solubilized or suspended dye in the wash solution, also known as “fugitive” or “stray” dyes, can easily deposit onto a different fabric or to undesired locations on the same fabric. Dye carry-over is commonly referred to as “dye transfer”. Nearly everyone is familiar with the process of segregating white fabrics from dyed fabrics to reduce the risk of undesired discoloration of the white fabrics.

Fabric washing is undertaken for a number of reasons including cleaning, softening, preparing the fabric for reaction, and fading the fabric. Even in cases where dye release from fabric is desired, as in fading denim jeans, re-deposition of the dye may not be (as when the dye released from denim jeans re-deposits on the jeans in a fashion so as to destroy the “worn look” which is sought).

Dye transfer during the laundering is dependent on a number of factors including the type of dye on the fabric (e.g. direct, acid, disperse, reactive, basic, vat), the type of fabric to which the dye is attached (e.g., cotton, nylon, polyester, acrylics), the milieu of the wash solution (e.g. temperature, surfactant concentration, pH of the solution), the length of cycle time (i.e., the length of exposure of the fabric to the wash solution) and exposure of the fabric to other materials found within the wash solution (e.g., minerals, perfumes etc.). In general, dye transfer is more prevalent in the wash cycle than the rinse cycle due to the higher water temperature, longer cycle time and much higher surfactant concentration in solution.

The difficulty in preventing the adverse effects of dye bleed is seen in the wide variety of fabrics that are typically washed together. For example, direct, azo and reactive dyes are used primarily to color cotton and rayon, acid dyes are used primarily to color wool, silk and nylon, disperse dyes are used primarily to color polyester and Spandex, and vat dyes are used to primarily to color cotton. Spandex, nylon, rayon and cotton fabrics have a strong propensity to pick up solublized and/or suspended dyes from solution, while fabrics such as polyester pick up such dyes to a lesser extent. On the other hand, dyes are more likely to desorb from cotton than from synthetic fabrics, such as acrylic, nylon or polyester.

The many different dyes used to color fabrics each display a different reactivity profile. For example, some dyes may be anionic, cationic, non-ionic or amphoteric in aqueous solution, with their charge characteristic varying with the pH of the wash solution. Dyes belonging to the direct, reactive and acid dye categories are generally anionic in an aqueous solution, while dyes belonging to the basic dye category are generally cationic in an aqueous solution. Dyes classified as vat and disperse dyes are generally non-ionic in aqueous solution, but can be anionic or non-ionic depending on the dye and the pH of the aqueous solution. The large variation in dye chemistry has made it quite difficult for the prior art to develop a solution to prevent undesired transfer of dyes from one fabric to another or to different portions of a particular fabric. That is, one additive that will prevent the transfer of certain dyes, may not prevent the transfer of other dyes found on fabrics in the wash.

One method for dealing with dye transfer is to discover improvements in the affinity of a dye for the original fabric substrate. Numerous dye compositions and methods have been proposed to improve colorfastness. However, the fact remains that the majority of dyed fabrics bleed dye when placed in solution.

Another method for dealing with undesired dye transfer is utilization of a “filtering envelope.” (See, e.g., U.S. Pat. No. 4,494,264). Filtering envelopes are used to physically separate dye-generating material from the remaining laundry items. This approach suffers from the physical inconvenience of separating items and may result in decreased cleaning due to restricted movement of the enveloped items in the wash liquid.

Significant efforts also have been undertaken to discover compounds and/or formulations that inhibit transfer of those dyes that are commonly released from fabrics. The development of dye transfer inhibitors (“DTIs”) has been hampered not only by the wide variety of dye chemistries involved, but also by the need for the DTI to be non-reactive with other ingredients typically used in the wash and to possess chemical properties that do not adversely affect the purpose for which the wash is being undertaken.

Numerous compounds have been proposed as dye transfer inhibitors. Chlorine based bleaches have long been known to inhibit the transfer of certain dyes. However, almost equally as long such compounds have been known to be inadequate for this purpose due to their ability to fade the color of fabric. Early on, surface-modified cellulose, modified by polymeric amines to render the cellulose anionic and then treated with nitrogen compounds was proposed as an adsorptive mass for anionic dyes (See, U.S. Pat. Nos. 3,673,110 and 3,694,364). U.S. Pat. No. 3,816,321 to Kleinschmidt discloses a laundering aid comprising a water-insoluble, polyurethane-polyalkyleneimine combined with a detergent composition for adsorbing direct and vagrant anionic dyes from aqueous laundry media. U.S. Pat. No. 4,065,257 describes certain condensation products derived from organic amino compounds as dye transfer inhibitors comprising a minor portion of an organic compound containing at least one basic nitrogen atom to which is bound at least one residue containing a polyglycol ether chain and a minor portion of a reaction product of an aliphatic tertiary polyamine with an aliphatic dihalide.

U.S. Pat. No. 4,380,453 describes a system for controlling extraneous free flowing dyes or colorants in a liquid bath by using a dye scavenger, such as a quaternary ammonium compound or quaternary ammonium epoxy compound, on a textile substrate. The textile substrate is impregnated with the dye transfer inhibitor such as N-trisubstituted ammonium-2-hydroxy-3-halopropyl compounds or salts of epoxy propyl ammonium compounds such as glycidyltrimethylammonium chloride. The impregnating solution may contain other ingredients such as a base. The textile substrate is preferably a cellulosic textile material.

German Patent No. 3,519,012, to Web et al., published Nov. 27, 1986, teaches a detergent composition comprising non-ionic surfactants, PVP components, water soluble cationic components, and builders, to prevent dye transfer during the wash. Similarly, European Patent Application 265,257, published Apr. 27, 1988, to Elements et al., discloses detergent compositions containing a detergent active (preferably mixtures of anionic and non-ionic surfactants), a detergent builder, and a polyvinylpyrrolidone (PVP) mixture. PVP is believed to solubilize into the wash water to scavenge the free dye molecules, suspending the dyes and preventing them from redepositing onto fabrics. Unfortunately PVP is known to have decreased dye transfer inhibition performance when used in conjunction with anionic surfactants. Similarly, organic quaternary ammonium salts and vinylimidazoles (See, DE 3,840,056; H. U. Jager and W. Denzinger, Wirkungweise von Polymeren mit farbubertragungsinhibierenden Eigenschaften, Tenside Surf. Det. 28 (1991) 6, p. 428), known to be useful for inhibiting the transfer of certain dyes, are frequently found to be incompatible with anionic surfactants or to hinder their cleaning performance.

Antwerpen et al. teach the use of copolymers containing from 75 to 95 weight percent of vinyl monomers free from carboxylic acid and amide groups, 5 to 20 weight percent of at least one carboxylic acid amide, and from 0 to 5 weight percent of carboxylic acid monomers (CA 2115529), and copolymers containing 5 to 90 weight percent of acrylamidoalkylenesulfonic acid, and from 5 to 90 weight percent vinyl acetamide monomers, to prevent reabsorption of dissolved dyes (CA2104507). The copolymers of both of these patents suffer from the disadvantage of tending to be costly. The copolymer of CA2104507 further suffers from the disadvantage of containing sulfonic acid groups that tend to be less effective in inhibiting the deposition of anionic or nonionic dyes.

DE 3124210 A1 discloses a liquid detergent formulation containing a nonionic or zwitterionic surfactant and one or more synthetic water soluble polymers selected from the following types: a polyacrylamide or a polyacrylamide partially hydrolyzed with a molecular weight over 1,000,000; a polyethyleneimine; a polyamine; and a polyamineamide. This formulation is not demonstrated in the application to be effective in preventing the transfer of numerous dyes, but rather only with respect to one type of dye—Sirius Bright Red F 4 BL.

Polyamine N-oxide containing polymers, and formulations thereof, are disclosed in European Patent Application No. 92202168.8, EP 579,295 and U.S. Pat. No. 5,478,489 as effective dye transfer inhibiting agents. Performance of such compositions is said to be improved by the presence of bleaching agents (See, U.S. Pat. No. 5,478,489).

U.S. Pat. No. 5,370,760 teaches a dye deposition inhibiting polymer containing, as polymerized units, from 5 to 100 weight percent of at least one vinyl amide monomer and from 0 to 95 weight percent of one or more vinyl ester monomers. The polymer is presently preferred to have less than 3 weight percent of one or more acrylamide monomers and less than 3 weight percent of one or more ethylenically unsaturated carboxylic acid monomers.

U.S. Pat. No. 5,698,476 discloses a system for removing extraneous, random free-flowing dyes from laundry washing applications comprising a support matrix having a dye absorber which has the ability to impart a color to the underlying support matrix when washed and a dye transfer inhibitor that is releasably associated with the support matrix such that the dye transfer inhibitor can be delivered to the wash liquor. The dye absorber used preferably results in at least a 10% increase in the level of dye absorption of the support matrix as compared to the support matrix alone. The dye absorber may include quaternary ammonium-hydroxy-haloalkyl compounds.

U.S. Pat. No. 5,534,182 discloses laundry detergent and fabric softening formulations comprising 0.1 to 15 percent by weight of one or more dye transfer inhibiting agents selected from the group consisting of a polyethoxylated urethane, and an acrylamide containing polymer having a molecular weight from about 2,000 to about 500,000. U.S. Pat. No. 5,534,182 further discloses that non-ionic and organic conventional aqueous thickners, such as polyethoxylated urethanes and cellulose esters, are useful dye transfer inhibiting agents in the laundry process. U.S. Pat. Nos. 5,804,219 and 5,932,253 also describe fabric-softening compositions with dye transfer inhibitors and methods for using the same to reduce dye transfer. The fabric softening compositions are said to comprise from about 0.03% to about 25% water soluble polymeric dye transfer inhibiting agents selected from the group consisting of: (A) polymers with one or more monomeric units containing at least one ═N—C(═O)— group, which are not enzymes, having an average molecular weight of from about 500 to about 100,000; (B) polymers with one or more monomeric units containing at least one N-oxide group having an average molecular weight of from about 500 to about 1,000; (C) polymers containing both ═N—C(═O)— and N-oxide groups of (A) and (B); (D) mixtures thereof.

U.S. Pat. No. 5,804,547 relates to an improvement in dryer-activated laundry additive compositions wherein the composition contains ingredients to reduce color losses due to the laundering process. The patent discloses that the composition comprises from 0.1 % to about 50% by weight of a composition having the formula (R₁)(R₂)N(CX₂)ₙN(R₃)(R₄) where X is selected from the group consisting of hydrogen, linear or branched, substituted or unsubstituted alkyl having 1 to 10 carbon atoms, and may comprise a cyclic group, n is an integer from 0 to 6, and R1, R2, R3 and R4 each is individually or independently selected from the group consisting of: hydrogen, alkyl, alkaryl, arylalk, hydroxyalkyl, polyhydroxyalkyl, polyalkylether, alkoxy, polyalkoxy, alkaryl, arylalk, hydroxyalkyl, polyhydroxyalkyl, carboxylic acid, dicarboxylic acid, phosphonic acid and alkyl phosphonic acid, linear or branched carboxylic acid and water soluble salts thereof.

U.S. Pat. No. 5,881,442 discloses a substrate material supporting a dye scavenging compound which is removably secured within a washing machine during its operation, wherein the substrate material is substantially prevented from commingling with the items within the washing machine while exposing the dye scavenging compound to the liquid within the washing machine. The presently preferred dye-scavenging agent is said to be a quaternary salt of dimethylamine epichlorohydrin, preferably a polymer of about 10 to about 100 units.

While halogenated poly-epoxyamines and ammonium hydroxy halopropyl compounds have been known in the prior art to be dye scavengers (See, U.S. Pat. No. 4,380,453), such compounds have not found favor due to their relatively low capacity for holding dye substances. For example, U.S. Pat. No. 5,698,476 reports that more than thirty-two individual 8″×11″ sheets prepared using a disclosed preferred substrate (i.e., a cellulosic textile) and dye scavenging agent (i.e., a quaternary 2-hydroxy-halopropyl compound of the patent) were required to obtain the same dye transfer inhibition profile of approximately 1.75 grams of polyvinyl pyrrolidone impregnated into a single dye transfer inhibitor sheet.

Other substances have also been studied as dye transfer inhibitors including: polyvinyl alcohol (Canadian Patent No. 2,104,728), cationic starches (U.S. Pat. No. 4,756,849; EP 044003), minerals such as magnesium aluminate and hydrotalcite (U.S. Pat. Nos. 4,392,961, 4,661,282, 4,929,381 and 5,149,456), polyvinyl oxazolidone (DE 2,814,329), enzymatic systems including peroxidases and oxidases (U.S. Pat. Nos. 5,273,896 and 5,288,765, and WO-91-05839), oxidants (U.S. Pat. Nos. 4,005,029, 4,123,376, 4,300,897 and 4,338,210), cationic and amphoteric surfuctants (U.S. Pat. Nos. 4,239,659 and 4,261,869), and propylene oxide reaction products (U.S. Pat. No. 4,389,214).

Dye transfer inhibitor compositions of the prior art suffer from a number of disadvantages. Many are limited with respect to the particular dyes that they inhibit the transfer of. Others require relatively expensive components making them commercially disadvantageous. A number of the DTIs lack substantial evidence of their safety in the environment that is particularly problematic when designed to be disposed of along with the wash solution. There is a need therefore for a dye transfer inhibitor composition and process which inhibits the transfer of a multiplicity of dyes which are typically released upon washing, which is relatively inexpensive, and which does not pose a potential environmental threat by disposal in the wash solution.

### SUMMARY OF THE DISCLOSURE

The present invention overcomes many of the problems associated with prior art dye-scavenging materials. The present invention provides improved control over dye transfer due to dye bleeding by providing a highly charged material with a high retention capacity for many of the dyes that are frequently released during the washing process. The highly charged material is produced by means of a multiple reaction scheme that maximizes binding of a epoxy-charge modifier having fixed formal charge to the substrate, thus providing a formal charge to the substrate.

The present invention provides a composition and process for segregating a multiplicity of dyes from articles in a wash. The process comprises reacting a solid matrix having, or treated to have, free amine or carboxylic groups on its surface, with a epoxy-charge modifier having fixed formal charge, advantageously a poly-epoxyamine, to modify the charge of the solid matrix. Preferably, the process entails use of one or more amino cross-linking agents to induce production of free amino groups on the solid matrix and to form relatively strong bonding links between functionalities of the epoxy charge-modifier and the solid matrix. Advantageously, a poly-epoxyamine is a polymer of more than about two repeating units, more advantageously more than about 5 repeating units, and yet more advantageously more than about 10 repeating units, which contain quaternary amines in each monomer.

### DETAILED DESCRIPTION OF THE DISCLOSURE

For purposes of illustrating the features of the present invention, the solid matrix employed in the examples and below description of the disclosure is advantageously a polyester substrate. By “polyester substrate” it is meant a high surface area porous non-woven fabric made from fiber, particulate, or some combination of both, which is made from polymers in the polyester family (e.g., polytrimethylene terephthalate, polyethylene terephthalate [PET] or polybutyl terephthalate [PBT]), their copolymers, or blends having polyester as at least one of its components. These fabrics may take the form of spunbond or meltblown media.

The ability of other suitable materials to be used as matrices notwithstanding, a polyester substrate which is charge-modified by the methods of the present invention has been found to possess significant dye scavenging activity, in particular with respect to fabric dyes that are commonplacedly bled into wash fluids, among other things.

The modification to the polyester by the reaction with the modifying one or more epoxy groups results in changes to the characteristics of the polyester. For example, a negative or positive charge may be added, and hydrophilic or hydrophobic properties may be imparted.

Thus, in one embodiment of the present disclosure, there is disclosed a surface-modified polyester, manufactured by the steps of exposing the polyester to one or more agents sufficient to cause hydrolysis of the polyester and at least one modifier comprising one or more epoxy groups having either a positive or negative charge, or hydrophilic or hydrophobic properties, wherein the one or more epoxy groups bond with the polyester and impart the positive or negative charge, or hydrophilic or hydrophobic properties to the polyester. The exposures may take place concurrently or sequentially.

Surprisingly, the present inventors have discovered that when polymerized, certain epoxy propyl ammonium compounds, which were described in U.S. Pat. No. 4,380,453, may advantageously be employed to charge-modify a polyester substrate to produce very efficient dye scavengers with significant dye scavenging capacity. The dye scavenging capacity of polyester substrate treated with such polymers was found to be substantially improved by exposure (prior or concurrent) of the material to alkaline hydrolysis, in particular carried out using aliphatic polyamines. By “alkaline hydrolysis” it is meant a superficial, predominantly surface, treatment of the polyester substrate by an aqueous base solution such that the surface is altered without weakening the physical integrity of the polyester substrate. Alkaline hydrolysis is believed to produce carboxyl functional groups on the surface through chain scission. A presently preferred range of pH for alkaline hydrolysis of the present invention is about 12 to about 13. Alkaline hydrolysis of polyester is typically improved by employment of a wetting agent in the alkaline hydrolysis process, such as methanol or other low molecular weight alcohols in a bath concentration of about 10 to about 20%.

Dye scavenging capacity was also found to be improved by exposing the material to an aminolysis. By “aminolysis” it is meant a superficial, predominantly surface, treatment of the polyester substrate by an amine (preferably aliphatic rather than aromatic). Low molecular weight aliphatic amines that are water or water/alcohol soluble may be used most effectively. Aliphatic amines such as tetraethylene pentamine and diethyl tetramine may be employed advantageously. The dye scavenging capacity of numerous materials, in particular polyester substrate, was found to be substantially enhanced by aminolysis coupled with alkaline hydrolysis.

Unexpectedly it was found that a polyester substrate could be charged modified using the techniques described herein so as to form a material with extraordinary dye-scavenging capacity. Previously, the art had directed one towards use of materials having a high degree of hydroxyl functionalities which may easily be converted to anionic functional groups (See, e.g., U.S. Pat. No. 5,881,412 at Col. 6, Lines 48-50). In particular, presently preferred dye-scavenging matrices have been fabricated from cellulosic materials (See, e.g., U.S. Pat. No. 4,380,453 at Col. 2, Lines 47-49) such as cotton and rayon. By treating a polyester substrate with a polyamine in the presence of an alkaline agent (or sequentially reacting the same), and reacting with a epoxy-charge modifier having fixed formal charge, in particular poly-epoxyamine, the present inventors have found that significant charge addition can easily be effectuated on polyester substrates. While not wishing to be bound by any theory, the inventors have hypothesized that reactivity of polyester with the polyamine/alkaline solution involves a chemistry distinct from that involved in converting free hydroxyl moieties to anions, involving both addition of free amine functionalities to the polyester through formation of amide-linkages, and hydrolysis of the polyester to yield free carboxyl moieties. It is further believed that such free amine and carboxyl moieties react with the epoxy functionality of the epoxy-charge modifier having fixed formal charge permitting the charged-functionality of the epoxy-charge modifier to be chemically bonded to the polyester. The reaction scheme is believed to proceed as follows:

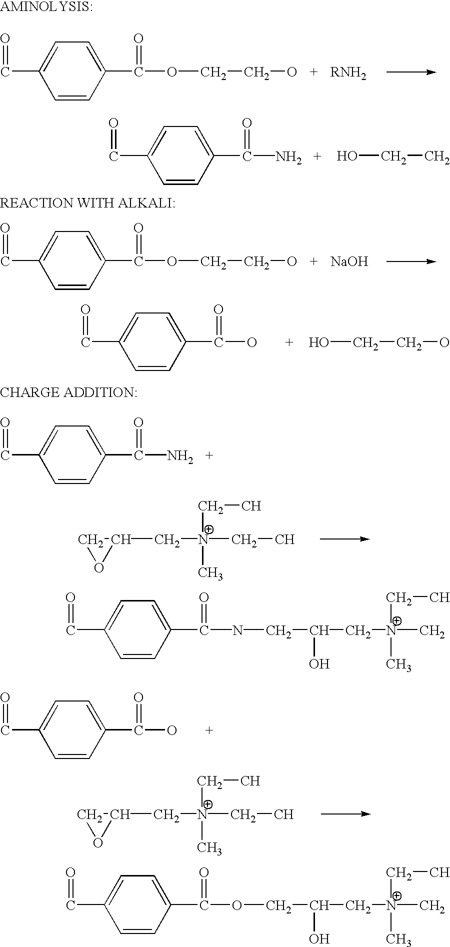

Charge modification may be accomplished by combining an aliphatic amine with an aliphatic diepoxide (e.g., 1,4 butanediol diglycidyl ether) in a reaction bath. Charge modification may also be accomplished by combining an aliphatic amine with a quaternary polyamino epichlorohydrin resin (e.g., Resicart E™, Ciba-Geigy®).

The amine used in the aminolysis reaction is preferably of the aliphatic type or predominantly aliphatic in nature. Aliphatic amines have been found to provide improved results as compared to aromatic amines. In particular, aliphatic amines of the ethyleneamine and propyleneamine group of compounds has been discovered to be particularly efficacious. Aliphatic amines comprising more than one reactive amine group have been seen to be significantly more effective than monoamines.

While sodium hydroxide is shown in the above reaction scheme, as would be understood by one of ordinary skill in the art, other alkaline agents may be advantageously employed. Advantageously, the pH of the solution to which the polyester substrate is exposed is greater than 7, more preferably greater than 8, and yet more preferably greater than 9.

As shown, a presently preferred charge-modifier of the present invention is a poly-epoxyamine. While one or more amine functionalit(ies) of such charge modifier is preferably quaternary, the charge modifier may comprise primary, secondary or tertiary amines. When used in a solution with a pH greater than 7, the poly-epoxyamine preferably comprises one or more quaternary amines.

It has been reported (Textile Progress: Surface Modification of Polyester by Alkaline Treatments in Textile Institute Vol2, No. 2, pp. 1-26 (1989)) that the affinity of polyester fiber fabric for moisture can be significantly improved by treating the fabric with alkaline or amine agents. It has been hypothesized that polyester undergoes nucleophilic substitution and is hydrolysed by alkaline agents, such as aqueous sodium hydroxide. It is believed that hydroxyl ions attack the electron-deficient carbonyl carbons of polyester to form an intermediate anion, followed by chain scission to produce free hydroxyl and carboxylate end-groups. Reports of improvement of certain physical properties of polyester by reactions with amines has been known almost since the discovery of polyester (See, e.g., U.S. Pat. No. 2,590,402 (Mar. 25, 1952)). It is similarly hypothesized that polyester undergoes nucleophilic substitution during aminolysis. It is believed that the amine attacks the electron-deficient carbonyl carbon with subsequent chain scission occurring at such site, and amide formation. It has been suggested that the amine groups on the surface of the polyester may provide sites for subsequent chemical reactions.

The dye scavenging capacity of polyester substrate undergoing alkaline hydrolysis and reaction with the epoxy-charge modifier, while significantly better than polyester substrate treated with sodium hydroxide and a haloglycidylammonium monomer, was not found to be as great as compared to polyester substrate undergoing both aminolysis and alkaline hydrolysis and reaction with the epoxy-charge modifier having formal fixed charge.

Likewise, aminolysis of the polyester substrate without alkaline hydrolysis, while improving the dye-scavenging capacity of the polyester substrate, did not provide the high dye scavenging capacity producible by exposing the polyester substrate to both aminolysis and alkaline hydrolysis along with reaction with the epoxy-charge modifier with fixed formal charge groups. The dye scavenging capacity of polyester substrate was found to be directly related to the charge placed on the polyester substrate. While not being bound thereby, it is believed that the improved charge on the polyester substrate when a polyepoxyamine charge modifier is utilized is due to an improved binding between the fixed formal charge group of the charge modifier and the polyester substrate, and the polymerized form of epoxyamine utilized.

In one method polyester substrate undergoes alkaline hydrolysis and the resulting intermediate is then charged modified with an epoxy charge-modifier, such as an aliphatic diepoxide or quaternary polyaminoepichlorohydrin resin. In another method, the polyester substrate is treated to cause aminolysis, and then resulting intermediate is then reacted with the epoxy charge-modifier. In yet another method, the polyester substrate is exposed to a bath containing alkaline agents and amines sufficient to cause both alkaline hydrolysis and aminolysis, and the resulting intermediate then treated with an epoxy charge-modifier. And yet in another method, the polyester substrate is exposed to a bath containing alkaline agents, amines, and an epoxy charge-modifier in sufficient concentration to cause aminolysis, alkaline hydrolysis, and charge-modification by chemical reaction of the epoxy charge-modifier with the modified polyester substrate.

The treated polyester substrate is typically dried after all treatments (it is not necessary to dry the treated polyester substrates until all desired treatments are complete). Treated polyester substrate can be prepared by a number of methods, as would be understood by one of ordinary skill in the art from the present disclosure.

A first embodiment of surface modification in accordance with this invention is through the chemical reaction between the epoxy groups of the surface modifying agent and the hydroxyl, carboxylic, or amino groups generated from the hydrolysis of polyester fibers.

Hydrolysis reveals functional groups on polyester for further reactions. Reactions can be conducted in either alkaline or amine solutions. A sample of proper size is pre-wetted prior to hydrolysis. Wetting can be conducted either by using a wetting agent, a surfactant, or simply by dipping the sample in an aqueous alcohol solution. Wetting and hydrolysis can be a two-step process or can be processed in one step. In this embodiment of the invention, a sample of Reemay2295 is soaked in a solution that contains from 20-25% methanol, preferably 23% methanol, 0.1-0.3% sodium hydroxide, preferably 0.2% sodium hydroxide. The reaction temperature can be from room temperature to the boiling point of the solution. However, the temperature must be sufficiently low enough to avoid excessive hydrolysis of the polyester which may weaken the substrate. In this embodiment, a temperature of 25-85° C., and preferably 60-70° C., were been used to perform the hydrolysis.

When hydrolysis is conducted in an amine solution, the reaction can be presented by the following equation:

˜CO—C₆H₄—CO₂—CH₂—CH₂—O˜+RNH₂→˜CO—C₆H₄—CO—NHR+HO—CH₂—CH₂—O˜

This is a nucleophilic substitution reaction, called aminolysis, in which the electron-rich amine will attack electron-deficient carbonyl carbon of carboxylic group and cause chain scission at this site.

When hydrolysis is conducted in an alkaline solution such as in NaOH solution, the reaction can be presented by the following equation:

˜CO—C₆H₄—CO₂—CH₂—CH₂—O˜+NaOH→˜CO—C₆H₄—CO₂⁻+HO—CH₂—CH₂—O˜

This is also a nucleophilic substitution reaction, called alkaline hydrolysis, in which the electron-rich hydroxide attacks electron-deficient carbonyl carbon of carboxylic group and cause chain scission at this site.

Both reactions cause the molecular weight of polyester to reduce and excessive hydrolysis, which may make the polyester fabric too weak to be useful if mechanical strength is needed in application, should be avoided.

Polyesters such as PET and PBT, after reacting with alkaline or amine solution in a controlled manner, open up new functional carboxylic or amino and hydroxyl groups. Each of these groups can further react with an epoxy group. Examples of groups of compounds which carry epoxy groups and can be utilized in the present invention are described herein below.

The first group comprises available charge-carrying polymers that carry epoxy group on their repeat units, such as Resicart E (Ciba-Geigy), shown below.

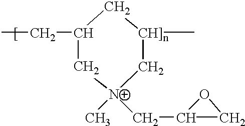

The second group comprises an acrylic-epoxy monomer (such as GMA) polymerized with another acrylic monomer that carries a charge. Example of other monomers is 2-acrylamido-2-methyl-1-propanesulfonic acid (CAS 15214-89-8), and thus, offer charges to substrate polyester after the reaction of epoxy group of GMA with carboxylic or amino and hydroxyl groups on substrate. This is illustrated below:

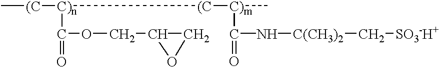

Another example of another monomer is diethyl aminoethyl methacrylate (DEAEMA) with a reacted polymer structure shown below:

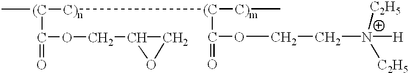

The third group comprises modifying agents that are adducts of a multi-epoxy compound such as Heloxy 67 and a multi-amine molecule such as tetraethylenepentamine (TEPA).

The fourth group comprises modifying agents that are condensed products of epichlorohydrin with a high molecular weight polymer with an amine functionality on the main chain. An example is given below:

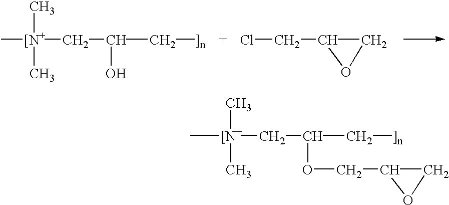

The fifth group comprises an acrylic-epoxy monomer such as GMA which can be polymerized with a vinyl monomer that has a special functional group, such as a styrene sulfonic acid group, which would impart anionic charge modification.

The sixth group comprises monomers containing hydroxyl groups such as hydroxyl ethyl methacrylate (HEMA) or hydroxyl propyl acrylate (HPA) can polymerize with epoxy-containing acrylate such as GMA and after reacting onto polyester, the polymer can alter the surface energy of the polyester, making it more hydrophilic.

The seventh group comprises monomers such as fluoroalkyl methacrylate or acrylate could be polymerized with epoxy-containing acrylate such as GMA to alter the surface energy of the polyester, making it more hydrophobic.

The amine used in the aminolysis reaction is preferably of the aliphatic type or is predominantly aliphatic in nature. Aliphatic amines have been found to provide improved results as compared to aromatic amines. In particular, aliphatic amines coming within the ethyleneamine and propyleneamine group of compounds has been discovered to be particularly efficacious. Aliphatic amines comprising more than one reactive amine group have been seen to be significantly more effective than monoamines in inducing aminolysis.

While sodium hydroxide is shown in the above reaction scheme, as would be understood by one of ordinary skill in the art, other alkaline agents may be advantageously employed. Advantageously, the pH of the solution to which the polyester is exposed is greater than about 7, more preferably greater than about 8, and yet more preferably greater than about 9.

As shown, the presently preferred charge-modifier of the present invention is a poly-epoxyamine. While one or more amine functionalit(ies) of such charge modifier is preferably quaternary, when a positive zeta potential is desired, the charge modifier may comprise primary, secondary or tertiary amines. When used in a solution with a pH greater than about 7, the poly-epoxyamine preferably comprises one or more quaternary amines. However, as would be understood by one of ordinary skill in the art, other ions other than ammonium ions which have a fixed formal positive charge group may be used as well.

The dye scavenging capacity of polyester fabric reacted without aminolysis (i.e. reacted with the poly-epoxyamine and sodium hydroxide alone), while significantly better than polyester fabric treated with sodium hydroxide and a haloglycidylammonium monomer, was found to be significantly reduced as compared to the capacity of such fabric when the fabric was also reacted with a amine compound to cause aminolysis of the polyester. While not being bound by any theory, it is believed that the improved charge capacity of the fabric is due to an improved binding between the amine group of the charge modifier and the polyester substrate due both to the improved bonding caused by aminolysis with the amine and due to the polymerized form of epoxyamine utilized.

The present inventors have discovered that aminolysis of polyester substrate made from linear poly(ethylene terphthalate), in conjunction with alkaline hydrolysis of the polyester, significantly improves the anionic dye binding capacity of the treated polyester when further treated with epoxy charge-modifiers having a fixed formal positive charge group, in particular glycidyltrialkylammonium compounds. The present inventors have also discovered that polymerized epoxy-containing charge-modifiers permit significantly more charge to be built up on many substrates as opposed to their monomeric analogs.

In a presently preferred embodiment of the present disclosure, polyester material is treated with an aliphatic polyamine and/or a strong alkaline compound to cause alkaline hydrolysis prior to, or concurrent with, treatment of the material with the poly-epoxy charge-modifier. A particularly presently preferred aliphatic polyamine has been found to be tetraethylene pentamine (H₂N(CH₂CH₂NH)₃CH₂CH₂NH₂). Numerous alkaline agents can be used as long as the agent can induce hydrolysis of the polyester to produce free carboxyl groups; however, amine linking agents are presently preferred. For economic reasons, it is presently preferred that the alkaline agent used to cause alkaline hydrolysis of the polyester be a strong base such as sodium or potassium hydroxide.

It is presently preferred that either prior to, or concurrent with, reaction with the alkaline agent that the material be wetted with an alcohol solution, presently preferably 10-30% methanol.

The epoxy charge-modifier with fixed formal positive charge is preferentially polymeric in form, comprised of two or more repeating units, more preferably 50 or more repeating units, and more preferably 100 or more repeating units. While the charge modifier may comprise primary, secondary, tertiary or quaternary amines, quaternary amines are presently preferred as they maintain charge in substantially all pH ranges, including alkaline pH. Quaternary amines are particularly presently preferred when the pH of the washing fluid is higher than about 7.

The treated polyester may be dried after all treatments (it is not necessary to dry the treated polyester substrates until all desired treatments are complete). Treated polyester substrate can be prepared by a number of methods, as would be understood by one of ordinary skill in the art from the present disclosure.

In one method polyester substrate undergoes alkaline hydrolysis and the resulting intermediate is then charged modified with an epoxy charge-modifier, such as an aliphatic diepoxide or quaternary polyaminoepichlorohydrin resin. In another method, the polyester substrate is treated to cause aminolysis of the polyester, and then the resulting intermediate is reacted with an epoxy charge-modifier. In yet another method, the polyester substrate is exposed to a bath containing alkaline agents and amines sufficient to cause both alkaline hydrolysis and aminolysis, and the resulting intermediate then treated with an epoxy charge-modifier. And yet in another method, the polyester substrate is exposed to a bath containing alkaline agents, amines, and an epoxy charge-modifier in sufficient concentration to cause aminolysis, alkaline hydrolysis, and charge-modification by chemical reaction of the epoxy charge-modifier with the modified polyester substrate.

In one presently preferred embodiment of the present invention, there is disclosed a process for removing anionic materials from a liquid comprising exposing the liquid to a cationically charge-modified polyester substrate having a positive zeta potential such that the metanil yellow binding capacity is at least about 0.004 mg metanil/1.0 gram of substrate, the charge-modified polyester substrate comprising: (a) polyester; (b) a polymeric cationic charge-modifying agent, the cationic charge-modifying agent being chemically bonded to the polyester.

A further aspect of the present invention consists of charge-modified polyester substrate having a metanil yellow binding capacity of at least about 0.004 mg of metanil/1.0 grams of substrate.

### A Method for Measuring Metanil Yellow Dye Capacity

Metanil yellow solution at 10 ppm concentration is prepared in a phosphate buffer at pH 9. The media is soaked and then removed. The absorbance of the supernatant liquid is measured at a wavelength 430 nm and compared to a blank solution containing everything but the dye. The total metanil yellow bound was calculated as follows:

Total metanil yellow bound in milligrams=(Aᵢ−A_{f})/Aᵢ×(mg dye in offered volume)

where Aᵢ=the initial absorbance at 430 nm (blank) and A_{f}=final absorbance at 430 nm (test). The milligrams of dye in the offered volume may be easily calculated by using a standardized liter solution. For example, as 0.8 ppm=0.8 mg/l=0.8 mg/1000 ml, if 10 ml are used in the study, there are 0.008 milligrams in 10 milliliters, or 0.1 mg in 10 ml.

The total metanil yellow in milligrams bound can then be divided by the weight of media to provide milligrams of metanil yellow per grams of media.

Metanil binding may also be determined as a function of available surface area (rather than weight of substrate). Such measurement is typically a better indication of charge as metanil binding is typically a function of surface area rather than weight.

A matrix modified in accordance with the present invention has many applications. Using the present invention as a dye scavenger in the laundering process (i.e., in a machine operative for washing items in a liquid) is disclosed for the purpose of providing an illustrative example of certain features in a matrix modified in accordance with the present invention and not intended to be limiting in any manner.

In another embodiment of the present invention there is disclosed a wash-additive article comprising a charge-modified polyester substrate having a positive zeta potential and comprising a plurality of beta-hydroxy alkyl amine moieties. By beta-hydroxy alkyl amine it is meant a chemical functionality having a hydroxyl group attached to the beta-carbon spaced from a carbon bound to an amine. A presently preferred embodiment of the present invention entails a cationic charge modified material comprising: a) a polyester substrate; and b) a poly-epoxyamine charge modifier chemically bound to said polyester-based substrate by way of reactivity through one or more of its epoxy group(s). Another presently preferred embodiment of the present invention encompasses an article for addition to a wash effective for inhibiting the transfer of bleed dyes to items in the wash, the article comprising: a) a support matrix comprising polyester substrate; and b) a dye scavenger incorporating one or more quaternary amines chemically bound to said support matrix. And yet further disclosed is a filter medium sheet having enhanced capture potential for electronegative dyes in a dye contaminated liquid comprising polyester substrate chemically altered to incorporate a plurality of amine functionalities so as to have a positive zeta potential.

In another embodiment of the present invention, there is disclosed a method for scavenging dye in the wash liquid of a washing machine comprising the steps of: a) obtaining a charge-modified polyester substrate having a positive zeta potential and a metanil yellow binding capacity of at least 0.004 mg metanil/gram of substrate; and b) placing said charge-modified polyester substrate into said washing machine in such a manner that the substrate makes contact with the wash liquid of said washing machine during the wash cycle. Also disclosed is a method for minimizing dye transfer during the wash cycle of an automatic washing machine, comprising the steps of: (a) placing a load of fabrics into said washing machine along with a charge-modified polyester substrate having a positive zeta potential such that the metanil yellow binding capacity is at least about 0.004 mg metanil/1.0 gram of substrate; (b) starting the washing machine so as to cause said washing machine to enter into the wash cycle. Yet also disclosed is a method for controlling undesirable dye transfer with respect to a textile in a bath, comprising placing in the bath a dye scavenging material comprising a polyester substrate material bearing a dye scavenger material comprising a polymer having a plurality of quaternary amine moieties.

The present invention overcomes many of the problems associated with prior art dye-scavenging materials. The present invention provides improved control over dye transfer due to dye bleeding by providing a highly charged material with a high retention capacity for many of the dyes that are frequently released during the washing process. The highly charged material is produced by means of a multiple reaction scheme that maximizes binding of a epoxy-charge modifier having fixed formal charge to the substrate, thus providing a formal charge to the substrate.

In a presently preferred embodiment, a polyepoxyamine charge modifier with fixed formal positive charge is used, providing a substrate with positive charge or zeta potential. Preferably the zeta potential of the positively charged substrate is on the order such that it has a metanil yellow binding capacity of at least 0.004 mg metanil/1.0 gram substrate, more preferably at least 0.005 mg metanil/1.0 gram substrate, and yet more preferably at least 0.007 mg metanil/1.0 gram substrate. The process to produce such material is simple and cheap.

In other embodiments of the present disclosure, the surface modifier which reacts with the polyester may have one or more epoxy groups associated with one or more hydroxyl groups that results in a polyester substrate which is substantially hydrophilic, one or more epoxy groups associated with one or more ethylene oxide groups that results in a polyester substrate which is substantially hydrophilic, one or more epoxy groups associated with one or more hydroxyl and ethylene oxide groups that results in a polyester substrate which is substantially hydrophilic, or one or more epoxy groups associated with one or more groups that carry one or more fluorine atoms that results in a polyester substrate which is substantially hydrophobic.

The present inventors have discovered that aminolysis of n-polyester fibers made from linear poly(ethylene terphthalate) (“PET”), in conjunction with alkaline treatment, significantly improves the binding capacity of such materials for epoxyamines, in particular glycidyltrialkylammonium compounds. The present inventors have also discovered that polymerized epoxyamines provide significantly enhanced charge to be built up on PET as opposed to their monomeric analogs. While epoxyamines were found to provide unexpectedly good charge modification, as would be understood by one of ordinary skill in the art, other charge modifiers having functional groups other than epoxy groups may be used so long as the charge modifier carries functional groups that can react with carboxylic or amine groups directly, or through linking agents. For example, Polycup® resins (Hercules) may find employment in the presently disclosed processes.

In a presently preferred embodiment of the present invention, polyester substrate is treated with both an aliphatic polyamine and an alkaline compound prior to, or concurrent with, treatment with the charge-modifier having fixed formal charge. A particularly presently preferred aliphatic polyamine has been found to be tetraethylene pentamine (H₂N(CH₂CH₂NH)₃CH₂CH₂NH₂). Numerous alkaline agents can be used as long as the agent can induce hydrolysis of the polyester substrate to produce free carboxyl and/or hydroxyl groups. For economic reasons, it is presently preferred that the alkaline agent be a strong base such as sodium or potassium hydroxide.

When an epoxyamine charge-modifier is utilized, it is presently preferred that the charge-modifier be polymeric in form, comprised of two or more repeating units, more preferably five or more repeating units, and more preferably ten or more repeating units. While a epoxyamine charge-modifier may comprise primary, secondary, tertiary or quaternary amines, quaternary amines are presently preferred as they maintain their charge on polyester substrate when the pH of the washing fluid is higher than 7. Preferably an epoxyamine charge-modifier incorporates predominantly, if not exclusively, poly(quaternary amines). The epoxyamine charge-modifier may be aliphatic or aromatic, comprising ring or linear structures, or a combination thereof. It is presently preferred, however, that if epoxyamine charge-modifiers are utilized that aliphatic epoxyamines be used, such compounds having been found to generally provide enhanced charge-modifying effects with respect to polyester substrates. A particularly presently preferred and effective poly-epoxyamine contains a plurality of 2,3-epoxyalkylamine functionalities.

As polyester is typically cheaper than many other fabrics, a dye transfer inhibitor sheet composed of polyester may be disposed after each use. This provides a product that is always clean, fresh without stain and guaranteed to have charge to remove dyes.

Spunbond polyester substrate was presently preferred over meltblown because it was found to maintain better structural integrity in the washing machine. A laminate of PET/PBT, spun bond/meltblown, or any combination thereof may also be used as the substrate.

As would be recognized by one of ordinary skill in the art, while a charge-modified polyester substrate may be added directly into a wash solution to scavenge dye moieties, it is possible to remove dye moieties from a wash by routing the wash through the polyester substrate placed in a separate container. For example, a pressure vessel may be mounted onto the wash machine and wash water circulated there through. Wash water containing dye may also be passed through a column having charge-modified polyester substrate as an active component.

### EXAMPLE 1

### Charge Capacities

Each charged sheet, along with an untreated sheet made from Reemay 2295, was cut into 4-2.25″ squares for metanil yellow (M-Y) dye capacity testing. Duplicate samples were used in the following manner to perform a static M-Y dye test. Two sets of 2 squares were weighed and placed in disposable Petri dishes. A 10-ml solution of 10 ppm of M-Y in pH 9 buffer was pipetted into the dishes and swirled. After one minute, the samples were removed, and the absorbance of the supernatant liquid and the unused dye solution read on the LKB Ultrospec II spectrometer at 430 nm in the standard 1-cm cuvette. Calculations were then performed to determine the sample's capacity for dye.

The mg dye in offered volume is calculated as follows:

For 10 ppm=10 mg/l=10 mg/1000 ml.

As only 10 mls is being used, 10 ml/1000 ml=0.01*10 mg=0.1 mg in 10 mls

For a typical test, where the blank absorbance of a 10-ppm solution is 0.533 and the absorbance of the test sample's supernatant is 0.142,

The total M-Y bound, mg=(0.533−0.142)/0.533*0.1=0.073

The mg bound can then be divided by the weight of the media or the area used (10.125 cm²) to provide mg M-Y/g media or mg M-Y/cm² media. When challenged with 10 ml of 10-ppm metanil yellow for 1 min., the charge capacities are 0.008 mg/in² or 0.117 mg/g.

### EXAMPLE 2

### Preparation of Charge-Modified Polyester via Amine Hydrolysis

A piece of 2″×2¼″ Hollytex 3257 (a PET spunbond) was wet with 10% methanol and then treated with a 1% tetraethylene pentamine at 70° C. for 30 seconds. The material was then flushed with tap water to remove the excess amount of tetraethylene pentamine. The wet fabric was subsequently dipped into a 2% Rescart-E (poly(N-methyl diallyl amine) epichlorohydrin adduct—Ciba-Geigy) solution for about 5 seconds. The fabric was then dried at 90° C. for thirty minutes.

The treated fabric was then washed in a typical laundry wash containing Tide® detergent and Clorox® at 85° C. for thirty minutes. The fabric was then challenged with Metanil yellow dye and the dye uptake determined. The dye capacity of the fabric was determined to be 0.005 mg/g of polyester substrate.

### EXAMPLE 3

### Preparation of Charge-Modified Polyester via NaOH Hydrolysis I

A piece of 6″×6″ Reemay 2295, a spunbond with 2.2 denier fiber and 100 gms basis weight was placed in a reactor that contained 0.2 grams sodium hydroxide, 0.2 grams of methanol, and 2 ml of a 20% solution of Resicart-E (poly(N-methyl diallyl amine) epichlorohydrin adduct—Ciba-Geigy). Water was added to reactor to result in a total volume of 100 milliliters. The reactor temperature was maintained at 65° C.

The treated fabric was then dried and challenged with metanil yellow dye. The dye capacity of the fabric was determined to be about 0.005 mg/g of polyester substrate.

### EXAMPLE 4

### Preparation of Charge-Modified Polyester via NaOH Hydrolysis II

A charge-modifying agent is a copolymer of GMA and DEAEMA. GMA and DEAEMA were charged into a reactor in a weight ratio of 1:10 in a D.I. water medium with the pH of the solution adjusted to 3.5 to 4.5. The reaction was carried out in a nitrogen atmosphere at 80° C. in the presence of free-radical initiator APS and promoter STS. After the completion of the reaction, the solution became an opalescent white and viscosity increased slightly. Eighty ml of this solution was adjusted to pH>12 with NaOH, and 20 ml of MeOH were added to provide hydrophilicity. Two 7-inch squares of Reemay 2295 was added to the solution at room temperature for two minutes, put through the wringer and then dried at 105° C. The nitrogen content via Kjeldahl nitrogen analysis of control Reemay 2295 as <0.21 mg N₂/g, and the DEAEMA-GMA treated sample as 2.5 mg N2/g.

### EXAMPLE 5

### Preparation of Hydrophilic Polyester Fabric

The hydrophilic modifying agent is a copolymer of GMA and PEGMA. GMA and PEGMA were charged into a reactor in a weight ratio of 1:20 in a DI water medium with the pH of the solution adjusted to 4.0. The reaction was carried out in a nitrogen atmosphere at 80° C. in the presence of free-radical initiator APS and promoter STS. After approximately 30 minutes, a slight translucence was seen, which over 4 hours also showed a slight increase in viscosity.

### EXAMPLE 6

### Acid Dye Removal by Charge-Modified Polyester Fabric

Three different wash water from washing new colored articles were collected—red, blue and green. A positively charged polyester made from Example 3 was cut into 2″×2″ square and threw in a bottle of 50 ml colored water. Dyes of three different color can be removed within 5 minutes and leave the solution colorless.

### EXAMPLE 7

### Change of Surface Tension of Surface-Modified Polyester Fabric

Twenty-five ml of the solution prepared in Example 5 was brought to pH 13 by the addition of 5N NaOH. The solution was brought to 65° C., and 4 ml of methanol was added and a 7×8 inch rectangle of Hollytex 3257 was saturated for 2 minutes. The material was dried in a 72° C. oven, washed with water and re-dried. Single drops of DI water and saturated NaCl solution were timed to disappearance in a test for hydrophilicity. Wetting results were indicated in the following table.

| | DI, Avg. wetting | |
|---|---|---|
| Samples | time | Sat. NaCl, Avg. time |
| Untreated Hollytex 3257 | 22.72 sec | 156.14 sec |
| Water-rinsed 0726A | 13.19 | 22.72 |

Treatment of the dye scavenging material may take place using a multi- or single-step process. For example, the material may be processed sequentially through a pre-wet solution, a rinse, an alkaline solution, a rinse, an aliphatic polyamine solution, a rinse, and then a poly-epoxyamine solution (and then dried). The material may also be processed sequentially through a pre-wet solution, a rinse, and a solution containing both the poly-epoxyamine and the alkaline agent prior to drying. The material may also be processed by running it through a solution containing the poly-epoxyamine and alkaline agent along with an agent to promote drying (such as methanol).

While the invention has been described with respect to presently preferred embodiments, those skilled in the art will readily appreciate that various changes and/or modifications can be made to the invention without departing from the spirit or scope of the invention as defined by the appended claims. All documents cited herein are incorporated in their entirety herein.

What is claimed is:

1. A cationic charge modified material comprising:
a) a polyester-based substrate; and
b) a poly-epoxyamine charge modifier chemically bound to said polyester-based substrate by way of reactivity through one or more of its epoxy group(s).

2. A wash-additive article comprising:
a charge-modified polyester substrate having a positive zeta potential and comprising a plurality of beta-hydroxy alkyl amine moieties.

3. The article of claim 2 wherein the article is in the form of a flat or pleated sheet.

4. The article of claim 2 wherein the article is a pouch.

5. The article of claim 2 wherein the article is housed in a pouch.

6. The article of claim 2 wherein the article is enclosed in a vessel through which wash water may be circulated.

7. An article for addition to a wash effective for inhibiting the transfer of bleed dyes to items in the wash, the article comprising:
a) a polyester substrate;
b) a dye scavenger incorporating one or more quaternary amines chemically bound to said polyester substrate.

8. An article for use in a washing machine operative for washing items in a liquid, said article comprising a charge-modified polyester substrate having a positive zeta-potential.

9. A method for scavenging dye in the wash liquid of a washing machine comprising the steps of:
a) obtaining a charge-modified polyester substrate having a positive zeta potential;
b) placing said charge-modified polyester substrate into said washing machine in such a manner that the substrate makes contact with the wash liquid of said washing machine during the wash cycle.

10. A method for minimizing dye transfer during the wash cycle of automatic washing machine, comprising the steps of:
(a) placing a load of fabrics into said washing machine along with a charge-modified polyester substrate having a positive zeta potential;
(b) starting the washing machine so as to cause said washing machine to enter into the wash cycle.

11. A method for controlling undesirable dye transfer with respect to a textile in a bath, comprising placing in the bath a dye scavenging material comprising a polyester substrate material bearing a dye scavenger material comprising a polymer having a plurality of quaternary amine moieties.

12. A filter medium sheet having enhanced capture potential for electronegative dyes in a dye contaminated liquid comprising polyester substrate chemically altered to incorporate a plurality of amine functionalities so as to have a positive zeta potential.

13. A surface modified material comprising:
a polyester-based substrate; and
one or more epoxy groups chemically bound to the polyester-based substrate by way of reactivity through the one or more of epoxy groups.

14. The material of claim 13, wherein the epoxy group has a fixed formal charge.

15. The material of claim 13, wherein the epoxy group has hydrophobic properties.

16. The material of claim 13, wherein the epoxy group has hydrophilic properties.
